(19) United States
(12) Patent Application Publication
(10) Pub. No.: US 2009/0011313 A1
(43) Pub. Date: Jan. 8, 2009

(54) Fuel cell system

(76) Inventor: Inhyuk Son, Yongin-si (KR)

Correspondence Address: ROBERT E. BUSHNELL, 1522 K STREET NW, SUITE 300, WASHINGTON, DC, 20005-1202, US

(21) Appl. No.: 12/081,556

(22) Filed: Apr. 17, 2008

(30) Foreign Application Priority Data
Jul. 3, 2007 (KR) 10-2007-0066426

(51) Int. Cl. H01M 8/10

(52) U.S. Cl. 429/30

(57) ABSTRACT

A fuel cell includes a fuel case, a fuel distribution layer, an anode gas diffusion layer, a membrane electrode assembly comprised of an anode, a cathode and an electrolyte membrane interposed between the anode and the cathode, and a cathode gas diffusion layer. The fuel stored in the fuel case is distributed into the anode gas diffusion layer through the fuel distribution layer. The fuel in the anode gas diffusion layer is diluted by water generated in and transported from the cathode electrode layer. The anode gas diffusion layer is thick so that the fuel may be uniformly diluted. The fuel cell may use high concentration fuel so that the fuel cell can increase efficiency and output.

### CLAIM FOR PRIORITY

This application is based on and claims priority to Korean Patent Application No. 2007-0066426 filed on Jul. 3, 2007 in the Korean Intellectual Property Office (KIPO), the entire contents of which are hereby incorporated by reference.

### BACKGROUND

1. Field of the Invention

The present invention relates to a fuel cell system, and more particularly, to a passive fuel cell system that can increase efficiency and output by using high concentration fuel.

2. Description of the Related Art

A fuel cell is an electric power generating system that generates electrical energy by a chemical reaction of hydrogen contained in hydrocarbon group such as methanol and ethanol, and oxidants such as oxygen contained in air supplied separately.

The fuel cell typically is classified as a polymer electrolyte membrane fuel cell (hereafter, referred to as “PEMFC”) and a direct methanol fuel cell (hereafter, referred to as “DMFC”).

In general, the PEMFC includes a stack (or a main body of the fuel cell) generating electrical energy by a reaction of hydrogen and oxygen, and a reformer generating hydrogen by reforming the fuel. The PEMFC generates electricity at the stack by an electrochemical reaction of hydrogen supplied from the reformer, and air supplied from an air pump. Though the PEMFC has an advantage of high energy density and high output, it has problems because hydrogen gas is difficult to handle and additional equipment such as a fuel reformer, etc. for reforming methane, methanol and natural gas, etc. is required to produce hydrogen as fuel gas.

On the other hand, the DMFC generates electricity by an electrochemical reaction of hydrogen and oxygen by supplying methanol fuel and air to the stack directly. The DMFC has advantages of high energy density and high electrical power density, no need for additional equipment such as the reformer, etc. because liquid fuel such as methanol, etc. is directly used, and easy storage and fuel supply.

The DMFC includes a fuel cell having a membrane electrode assembly (hereafter, referred to as “MEA”) generating electricity substantially and a gas diffusion layer which is laminated on the membrane electrode assembly.

The DMFC can be made variously according to the main body structure of the fuel cell and an air supplying method. For example, the DMFC can be classified as an active type and a passive type. In the active type, the membrane electrode assemblies are stacked in the vertical direction, and fuel and air are supplied by a pump. In the passive type, the membrane electrode assemblies are arranged independently or stacked in the parallel direction, and fuel and air are supplied by contacting the membrane electrode assembly directly.

As the passive type fuel cell is not a circulating structure where fuel is supplied by a pump, energy density that means electricity generating efficiency and output becomes lower than the active type. Accordingly, the passive type needs to increase fuel concentration so as to heighten efficiency and output. However, if fuel concentration of the passive type fuel cell is higher than 5M, output and durability are degraded because of the fuel cross-over increase and chemical stability degradation of Nafion and HC membranes which are currently used as an electrolyte membrane.

### SUMMARY

The present invention provides an improved fuel cell.

The present invention provides an improved direct alcohol fuel cell.

The present invention provides a passive type direct alcohol fuel cell that can increase efficiency and output by using high concentration fuel.

According to one aspect of the present invention, there is provided a fuel cell, which includes: a membrane electrode assembly comprising an anode electrode layer, a cathode electrode layer, and an electrolyte membrane interposed between the anode electrode layer and the cathode electrode layer; an anode gas diffusion layer formed on the anode electrode layer; a cathode gas diffusion layer formed on the cathode electrode layer, the cathode gas diffusion layer being thinner than the anode gas diffusion layer; and a fuel case for storing fuel, the fuel case having a coupling hole into which the anode gas diffusion layer is inserted, a gas outlet, and a hydrophobic film covering the gas outlet to selectively emit gas from the anode gas diffusion layer to an outside of the fuel case.

The anode gas diffusion layer may further include a fuel distribution layer formed with an area corresponding to an area of the anode electrode layer, with one porous surface thereof. The fuel distribution layer may be made of polytetrafluoroethylene (PTFE) resin having a hydrophobic property. The gas outlet is formed on a region of the fuel case where the anode gas diffusion layer is mounted. The gas outlet may be formed on an upward surface of the fuel case. The hydrophobic film may be formed of any one selected from the group consisting of polytetrafluoroethylene (PTFE), polyethylene (PE), polypropylene (PP), and polyethylene terephthalate (PET).

The fuel cell may further include an anode gasket having an anode coupling hole into which the anode gas diffusion layer is inserted, the anode gasket mounted between the fuel case and the electrolyte membrane; and a cathode gasket having a cathode coupling hole in which the cathode gas diffusion layer is inserted, the cathode gasket surrounding a side surface of the cathode gas diffusion layer to prevent an oxidant supplied to the fuel cell from leaking. The anode gasket may be formed thinner than the anode gas diffusion layer. The anode gasket may be formed with a thickness corresponding to a thickness that subtracts a width of the gas outlet from a thickness of the anode gas diffusion layer.

According to another aspect of the present invention, a fuel cell may comprise: a fuel case storing fuel; a fuel distribution layer having pores and made of hydrophobic material, the fuel distribution layer distributing the fuel to an anode gas diffusion layer; the anode gas diffusion layer diffusing the fuel from the fuel distribution layer into an anode electrode layer, the anode gas diffusion layer diluting the fuel with water transported from a cathode electrode layer; a membrane electrode assembly comprising the anode electrode layer, the cathode electrode layer and an electrolyte membrane interposed between the anode electrode layer and the cathode electrode layer; and a cathode gas diffusion layer formed on the cathode electrode layer, the cathode gas diffusion layer diffusing air into the cathode electrode layer, a thickness of the cathode gas diffusion layer being thinner than the anode gas diffusion layer. The fuel distribution layer may be formed with an area corresponding to the anode electrode layer, and made of porous PTFE resin having a hydrophobic property.

According to another aspect of the present invention, a fuel cell may include: a fuel case storing fuel; a fuel distribution layer having pores and made of hydrophobic material, the fuel distribution layer distributing the fuel to an anode gas diffusion layer; the anode gas diffusion layer diffusing the fuel from the fuel distribution layer into an anode electrode layer, the anode gas diffusion layer diluting the fuel with water transported from a cathode electrode layer; a membrane electrode assembly comprising the anode electrode layer, the cathode electrode layer and an electrolyte membrane interposed between the anode electrode layer and the cathode electrode layer; and a cathode gas diffusion layer formed on the cathode electrode layer, the cathode gas diffusion layer diffusing air into the cathode electrode layer, a thickness of the cathode gas diffusion layer being thinner than the anode gas diffusion layer. A concentration of the fuel stored in the fuel case is equal to or more than 5 M. The fuel distribution layer may be made of material having thermal expansion coefficient of at least 12×10⁻⁵/° C.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic view illustrating a fuel cell system comprising a fuel cell according to one embodiment of the present invention;

FIG. 2 is a cross-sectional view illustrating the fuel cell according to one embodiment of the present invention;

FIG. 3 is a plane view illustrating the fuel cell of FIG. 2.

### DETAILED DESCRIPTION OF EMBODIMENTS

Hereinafter, embodiments of a fuel cell according to the present invention will be described in detail with reference to the accompanying drawings.

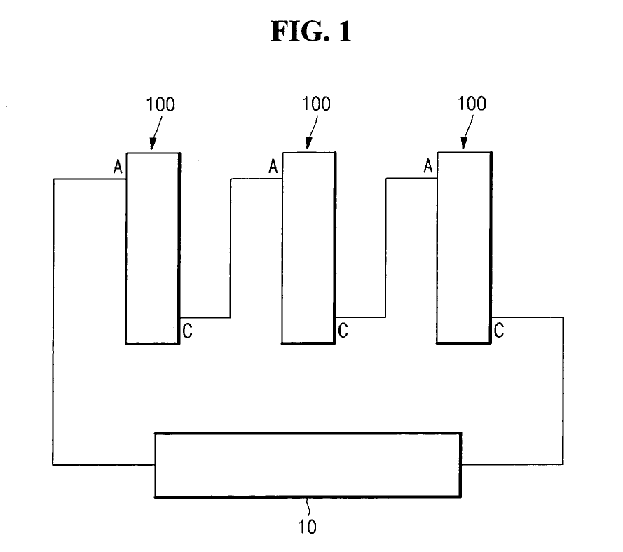

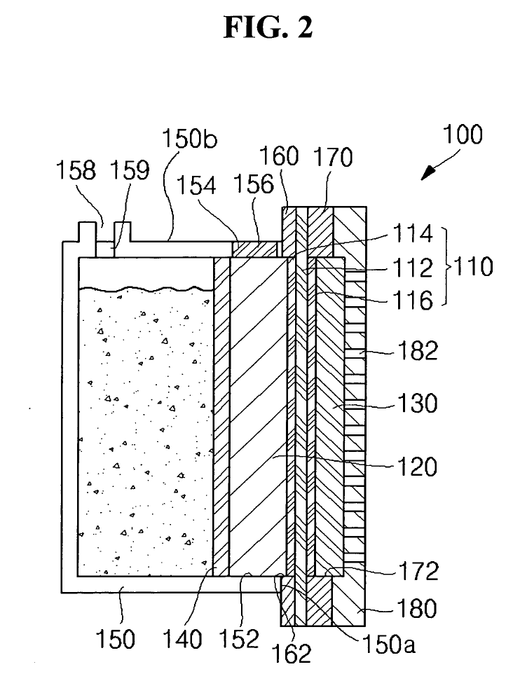

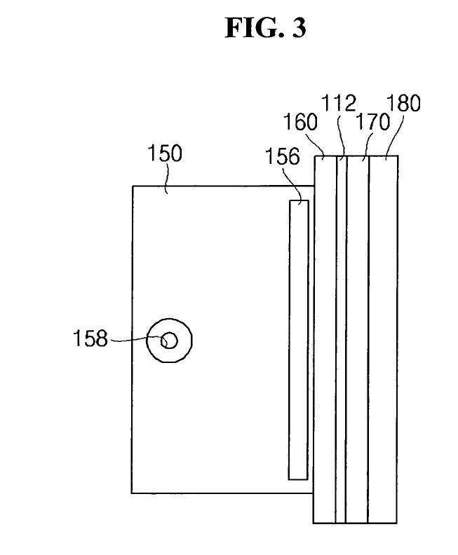

FIG. 1 is a schematic view illustrating a fuel cell system comprising a fuel cell according to one embodiment of the present invention. FIG. 2 is a cross-sectional view illustrating the fuel cell according to one embodiment of the present invention. FIG. 3 is a plane view illustrating the fuel cell of FIG. 2.

Referring to FIGS. 1 to 3, the fuel cell 100 includes a membrane electrode assembly 110, an anode gas diffusion layer 120, a cathode gas diffusion layer 130, a fuel distribution layer 140 and a fuel case 150. The fuel cell 100 further includes an anode gasket 160 and a cathode gasket 170 that cover each side surface of the anode gas diffusion layer 120 and the cathode gas diffusion layer 130, respectively. An outer electronic device 10 in FIG. 1 is connected to the fuel cell.

“A” is an anode electrode and “C” is a cathode electrode in FIG. 1. The fuel cell is formed by the anode electrode electrically coupled to the neighboring cathode electrode of the fuel cell.

A protecting cover 180 in FIG. 2 and FIG. 3 is installed at the outside of the cathode gas diffusion layer 130 so as to protect the cathode gas diffusion layer 130. The protecting cover 180 is formed with a lot of pores 182 so that outer gas can be diffused into the cathode gas diffusion layer 130.

The fuel cell 100 may be formed as a direct alcohol fuel cell such as direct methanol fuel cell (DMFC) and a direct ethanol fuel cell (DEFC) generating electric energy by oxidation of hydrogen contained in alcoholic fuel such as methanol, ethanol, etc. and reduction of oxygen contained in air. A plurality of fuel cells 100 may be stacked to form a fuel cell stack as shown in FIG. 1. The fuel cell 100 corresponds to an electricity generation unit for generating electricity by an electrochemical reaction.

The fuel cell 100 is formed as a passive type in which fuel is supplied by being in contact with the membrane electrode assembly 110 directly, and air is supplied by natural diffusion or a convective process.

The fuel cell 100 supplies fuel to the membrane electrode assembly 110 through the anode gas diffusion layer 120. When the fuel passes through the anode gas diffusion layer 120, the fuel is diluted by water which is generated in the cathode and flows into the anode gas diffusion layer 120. The thickness of the anode gas diffusion layer 120 is formed greater than the thickness of the cathode gas diffusion layer 130, so that fuel is uniformly diluted by water. The fuel cell 100 includes the fuel distribution layer 140 formed of porous materials on one surface of the anode gas diffusion layer 120. The fuel is uniformly and constantly supplied to the anode gas diffusion layer 120 by the fuel distribution layer 140. Accordingly, the fuel cell 100 can use high concentration fuel of equal to or more than 5 M in the fuel case 150. In other words, the fuel case can store high concentration fuel of more than 5 M.

The membrane electrode assembly 110 includes an electrolyte membrane 112, an anode electrode layer 114 and a cathode electrode layer 116. The membrane electrode assembly 110 generates electricity by a chemical reaction of fuel supplied from the anode electrode layer 114 and air from the cathode electrode layer 116. More particularly, the membrane electrode assembly 110 generates electricity by a chemical reaction of hydrogen contained in fuel and oxygen contained in air. Various membrane electrode assemblies 110 generally used for the fuel cell may be used as the membrane electrode assembly 110.

According to one embodiment of the present invention, the electrolyte membrane 112 is a polymer electrolyte membrane, and formed by polymer resin having hydrogen ion conductivity. For example, the electrolyte membrane 112 is formed by polymer resin selected from the group consisting of sulfonic acid group, carboxylic acid group, phosphate group, phosphonic acid group and their derivatives, and having a cation exchanger. The electrolyte membrane 112 is formed by various resins generally used for the fuel cell.

The electrolyte membrane 112 functions as a passage of hydrogen ions generated by oxidation of fuel, so that hydrogen ions can be transferred to the cathode electrode layer 116. The electrolyte membrane 112 also functions as a membrane electrically separating the anode electrode layer 114 from the cathode electrode layer 116.

The anode electrode layer 114 includes an electrode base material and a catalyst layer formed on the electrode base material. For example, the electrode base material may be formed of carbon materials such as graphite and acetylene black. The catalyst layer may include catalyst metal such as platinum, ruthenium, osmium, platinum-ruthenium alloy. The anode electrode layer 114 may include various electrode base materials generally used for the fuel cell and the catalyst layer.

The fuel is oxidized by the catalyst layer at the anode electrode layer 114, and electrons and hydrogen ions are generated by oxidation of fuel. The electrons are transferred to the cathode electrode layer 116 via an outer circuit, and hydrogen ions are transferred across the electrolyte membrane 112 to the cathode electrode layer 116.

The cathode electrode layer 116 includes the electrode base material and the catalyst layer formed on the electrode base material. For example, the electrode base material may be formed of carbon materials such as graphite and acetylene black. The catalyst layer may include catalyst metals such as platinum, ruthenium, osmium, platinum-ruthenium alloy. The cathode electrode layer 116 may include various electrode base materials generally used for the fuel cell and the catalyst layer.

Oxygen contained in air is reduced at the cathode electrode layer 116 by a reaction with electrons and hydrogen transported from the anode electrode layer 114. The electrons are transported to the cathode electrode layer 116 via an outer circuit which is connected to the cathode electrode layer 116 and the anode electrode layer 114. Hydrogen is transported across the electrolyte membrane 112 to the cathode electrode layer 116. The cathode electrode layer 116 generates moisture and heat by a reduction reaction.

According to one embodiment of the present invention, the anode gas diffusion layer 120 may be formed with a plate shape on one surface of the anode electrode layer 114, preferably, with an area corresponding to an area of the anode electrode layer 114. The anode gas diffusion layer 120 is formed thicker than the gas diffusion layer conventionally used for a fuel cell or the cathode gas diffusion layer 130. The anode gas diffusion layer 120 is in contact with fuel stored in a fuel case 150, and supplies fuel to the anode electrode layer 114.

The anode gas diffusion layer 120 mixes high concentration fuel supplied from the fuel case 150 with water flowing from the cathode electrode layer 116. The anode gas diffusion layer 120 is formed relatively thick, thereby extending time for fuel to reach the anode electrode layer 114. Accordingly, fuel flowing into the anode gas diffusion layer 120 flows into the inside of the anode gas diffusion layer 120 for relatively long. The anode gas diffusion layer 120 provides a space where water flowing from the cathode electrode layer 116 can be mixed with high concentration fuel. Accordingly, the anode gas diffusion layer 120 dilutes high concentration fuel supplied from the fuel case 150 with water flowing from the cathode electrode layer 116. In other words, the fuel is diluted with water generated at and flowing from the cathode electrode layer 116 when the fuel passes through the anode gas diffusion layer 120. The anode gas diffusion layer 120 dilutes high concentration fuel to relatively lower concentration fuel than fuel stored in the fuel case 150 so as to supply relatively lower concentration fuel to the anode electrode layer 114. Accordingly, the fuel cell 100 can use equal to or more than 5M of high concentration fuel.

According to one embodiment of the present invention, the cathode gas diffusion layer 130 is formed with a plate shape on one surface of the cathode electrode layer 116, preferably, an area corresponding to an area of the cathode electrode layer 116. The cathode gas diffusion layer 130 is formed with a thickness of a cathode gas diffusion layer generally used for the fuel cell. Accordingly, the cathode gas diffusion layer 130 is formed thinner than the anode gas diffusion layer 120. The cathode gas diffusion layer 130 is in contact with outside air, thereby supplying air to the cathode electrode layer 116. The cathode gas diffusion layer 130 exhaust outside or evaporate moisture generated by a deoxidation reaction at the cathode electrode layer 116.

The fuel distribution layer 140 m formed of a porous material on one surface of the anode gas diffusion layer 120. Preferably, the fuel distribution layer 140 is comprised of a porous polytetrafluoroethylene (PTFE) membrane having a hydrophobic property. The fuel distribution layer 140 allows fuel to be supplied to the anode gas diffusion layer 120 through pores formed in the fuel distribution layer 140, so that the fuel of the fuel case is uniformly supplied to the anode gas diffusion layer 120. A complete passive type fuel cell such as the fuel cell 100 does not use fuel supply equipment such as a fuel pump, which is used in an active fuel cell. In the passive type fuel cell 100, fuel is in contact with and diffused into the anode gas diffusion layer 120 to be supplied to the anode electrode layer 114. Accordingly, an amount of the fuel supplying to the anode electrode layer 114 can be varied according to an installed direction of the fuel cell 100 and fuel amount remained in the inside thereof. However, fuel in the fuel case 150 flows into the inside of the fuel distribution layer 140 at first, and then fuel is again supplied to the anode gas diffusion layer 120. Accordingly, the fuel distribution layer 140 can supply fuel to the anode gas diffusion layer 120 more uniformly. The anode gas diffusion layer 120 also enables high concentration fuel supplied from the fuel distribution layer 140 to be mixed more uniformly with water flowing from the cathode electrode layer 116. Accordingly, the anode gas diffusion layer 120 can supply a uniformly diluted fuel to the anode electrode layer 114. The anode electrode layer 114 generates electricity uniformly, thereby allowing performance and efficiency of the fuel cell 100 to be improved.

Comparing with other resin, the PTFE resin forming the fuel distribution layer 140 has large thermal expansion coefficient of 12×10⁻⁵/° C. If the temperature of the fuel cell 100 is increased wholly as an electrochemical reaction is progressed, the temperature of the fuel distribution layer 140 is also increased. Accordingly, the fuel distribution layer 140 is expanded as the temperature thereof is increased so that pores formed in the inside thereof become also large. The fuel distribution layer 140 more uniformly supplies more fuel to the anode gas diffusion layer 120 as the pores become large. In other words, the fuel supplied from the fuel distribution layer 140 varies according to the thermal expansion which varies according to working conditions of the fuel cell.

The fuel distribution layer 140 may be formed of hydrophobic materials to prevent moisture generated at the cathode electrode layer 116 from flowing into the inside of the fuel case 150. The fuel distribution layer 140 enables the moisture to remain in the inside the anode gas diffusion layer 120, so that the fuel flowing from the fuel case 150 into the anode gas diffusion layer 120 may be diluted more effectively.

According to one embodiment of the present invention, the fuel case 150 is formed with a box shape with a hollow inside, and a coupling hole 152 is formed to be opened to one side 150a of the fuel case 150. The fuel case 150 includes a gas outlet 154 at the upper part of the side where the coupling hole 152 is formed, and a hydrophobic film 156 shielding the gas outlet 154.

The anode gas diffusion layer 120 is inserted into the coupling hole 152 so that the inner side surface of the coupling hole is in contact with a side surface of the anode gas diffusion layer 120. Preferably, the coupling hole 152 has an area corresponding to the area of the anode gas diffusion layer 120 to broaden the area contacting the fuel.

The gas outlet 154 may be formed in a region of the fuel case 150 combined with the anode gas diffusion layer 120. Preferably, the gas outlet 154 is formed on an upper surface where the anode gas diffusion layer is mounted. The gas outlet 154 is formed with a width, preferably, corresponding to a thickness of the anode gas diffusion layer 120. Alternatively, the gas outlet 154 may be formed on a whole upward surface 150b of the fuel case 150. The gas outlet 154 connected with the anode gas diffusion layer 120 enables carbon dioxide which is generated at the anode electrode layer 114 and which flows into the anode gas diffusion layer 120 to be emitted to the outside of the fuel case 150.

The hydrophobic film 156 is made of a polymer having a hydrophobic property, and covers the gas outlet 154. For example, the hydrophobic film 156 is formed by any one selected from the group consisting of polytetrafluoroethylene (PTFE), polyethylene (PE), polypropylene (PP), and polyethylene terephthalate (PET).

The hydrophobic film 156 shields the gas outlet 154, and emits gas such as carbon dioxide flowing into the anode gas diffusion layer 120 to the outside. The hydrophobic film 156 also prevents fuel from being flowing to the outside of the fuel case 150. The hydrophobic film 156 selectively emits gas flowing into the anode gas diffusion layer 120 to the outside. Accordingly, the anode gas diffusion layer 120 enables fuel in the fuel case 150 and moisture flowing from the cathode electrode layer 116 to flow more effectively.

An outlet 158 emits gases such as carbon dioxide flowing into a space which is not filled by fuel in the fuel case 150. A hydrophobic film 159 selectively penetrates gas by covering the outlet.

According to one embodiment of the present invention, the anode gasket 160 has a plate shape which has a larger area than an area of the anode gas diffusion layer 120, and which has an anode coupling hole 162 in a center region. The anode gasket 160 is combined with one surface 11 of the electrolyte membrane 112 as shown in FIG. 2. The anode gasket 160 is installed between one surface of the electrolyte membrane 112 and the fuel case 150. Preferably, the anode coupling hole 162 has an area corresponding to an area of the anode gas diffusion layer 120. The anode gas diffusion layer 120 is inserted into the anode coupling hole 162 of the anode gasket 160. Accordingly, the anode gasket 160 covers a side surface of the anode gas diffusion layer 120. The anode gasket 160 is in contact with the fuel case 150 and the electrolyte membrane 112 as shown in FIG. 2. The anode gasket 160 prevents fuel and moisture flowing into the anode gas diffusion layer 120 from flowing to the outside. The anode gasket 160 can be formed by various resins generally used for the fuel cell.

According to an embodiment of the present invention, the anode gasket 160 is formed thinner than the anode gas diffusion layer 120. As the anode gasket 160 covers a side surface of the anode gas diffusion layer 120, it is difficult to form the gas outlet 154 if the anode gasket 160 is thicker than the anode gas diffusion layer 120. Accordingly, the anode gasket 160 is formed with a thickness corresponding to a thickness that subtracts a width of the gas outlet 154 from a thickness of the anode gas diffusion layer 120.

According to one embodiment of the present invention, the cathode gasket 170 has a plate shape which has a larger area than an area of the cathode gas diffusion layer 130, and which has a cathode combined hole 172 in a center region. The cathode gasket 170 is combined with one surface of the electrolyte membrane 112 as shown in FIG. 2. The cathode combined hole 172 may have an area corresponding to an area of the cathode gas diffusion layer 130. The cathode gasket 170 may be formed with a thickness corresponding to a thickness of the gas diffusion layer. The cathode gas diffusion layer 130 is inserted into and combined with the cathode combined hole 172 of the cathode gasket 170. Accordingly, the cathode gasket 170 surrounds a side surface of the cathode gas diffusion layer 130 to prevent air flowing from the outside from leaking, supporting the cathode gas diffusion layer 130. The cathode gasket 170 is formed by various resins generally used for the fuel cell.

A fuel cell according to another embodiment of the present invention will be described below.

First, when fuel is supplied to the fuel case 150, and air is supplied to the cathode electrode layer 116 at the fuel cell 100, an electrochemical reaction is progressed at the membrane electrode assembly 110. Hydrogen is ionized at the anode electrode layer 114 by the electrochemical reaction, and electrons are transported to the cathode electrode layer 116 via an outer circuit, and hydrogen ions are transported across the electrolyte membrane 112 to the cathode electrode layer 116.

Carbon dioxide generated at the anode electrode layer 114 flows into the anode gas diffusion layer 120, and flows out to the outside of the fuel case 150 through the gas outlet 154. In this time, as the gas outlet 154 is shielded by the hydrophobic film 156, gases such as carbon dioxide are selectively emitted outside. Some of moisture generated at the cathode electrode layer 116 is emitted outside through the cathode gas diffusion layer 130, and some of moisture flows into the anode gas diffusion layer 120 by passing through the membrane electrode assembly 110 and the anode electrode layer 114. The high concentration fuel flowing from the fuel case 150 pass through the pores uniformly formed in the fuel distribution layer 140. The fuel distribution layer 140 prevents water flowing into the anode gas diffusion layer 120 from flowing into the inside of the fuel case 150 due to its hydrophobic property. The fuel passing through the pores of the fuel distribution layer 140 flows into the anode gas diffusion layer 120, and is diluted by water flowing from the cathode electrode layer 116 and transported to the anode electrode layer 114.

The effects of the fuel cell according to the embodiments of the present invention include, but are not limited to, the followings.

The passive type fuel cell according to the embodiments of the present invention can increase efficiency and output of the fuel cell by using higher concentration fuel.

High concentration fuel can be used by forming the anode gas diffusion layer thicker than the cathode gas diffusion layer, diluting high concentration fuel supplied from the fuel case with water flowing from the cathode electrode layer, and supplying the diluted fuel to the anode electrode layer.

Efficiency and performance of the fuel cell can be improved by progressing electric generation reaction uniformly at the anode electrode layer because the fuel distribution layer can supply fuel more uniformly to the whole region of the anode gas diffusion layer.

The hydrophobic film is formed on the fuel distribution layer, thereby preventing moisture flowing from the cathode electrode layer from flowing into the inside of the fuel case and effectively diluting the fuel flowing into the anode gas diffusion layer.

The fuel distribution layer is expanded due to heat generated by the electrochemical reaction of the fuel cell to expand pores formed in the inside thereof and supply more fuel. Accordingly, the efficiency of the fuel cell is increased.

It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as limitations of the invention.

What is claimed is:

1. A fuel cell comprising:
a membrane electrode assembly comprising an anode electrode layer, a cathode electrode layer, and an electrolyte membrane interposed between the anode electrode layer and the cathode electrode layer;
an anode gas diffusion layer formed on the anode electrode layer;
a cathode gas diffusion layer formed on the cathode electrode layer, the cathode gas diffusion layer being thinner than the anode gas diffusion layer; and
a fuel case for storing fuel, the fuel case having a coupling hole into which the anode gas diffusion layer is inserted, a gas outlet, and a hydrophobic film covering the gas outlet to selectively emit gas from the anode gas diffusion layer to an outside of the fuel case.

2. The fuel cell of claim 1, further comprising a fuel distribution layer formed on the anode gas diffusion layer, the fuel distribution layer having pores to distribute the fuel stored in the fuel case to the anode gas diffusion layer.

3. The fuel cell of claim 2, wherein the fuel distribution layer is made of polytetrafluoroethylene resin having a hydrophobic property.

4. The fuel cell system of claim 1, wherein the gas outlet is formed on a region of the fuel case where the anode gas diffusion layer is mounted.

5. The fuel cell system of claim 1, wherein the gas outlet is formed on an upward surface of the fuel case.

6. The fuel cell of claim 1, wherein the hydrophobic film is made of one selected from the group consisting of polytetrafluoropolyethylene (PTFE), polyethylene (PE), polypropylene (PP), and polyethylene terephthalate (PET).

7. The fuel cell of claim 1, further comprising:
an anode gasket having an anode coupling hole into which the anode gas diffusion layer is inserted, the anode gasket mounted between the fuel case and the electrolyte membrane; and
a cathode gasket having a cathode coupling hole in which the cathode gas diffusion layer is inserted, the cathode gasket surrounding a side surface of the cathode gas diffusion layer to prevent an oxidant supplied to the fuel cell from leaking.

8. The fuel cell of claim 7, wherein the anode gasket is formed thinner than the anode gas diffusion layer.

9. The fuel cell of claim 8, wherein the anode gasket is formed of a thickness corresponding to a thickness that subtracts a width of the gas outlet from a thickness of the anode gas diffusion layer.

10. A fuel cell comprising:
a fuel case storing fuel, the fuel case having an opening;
a fuel distribution layer closing the opening of the fuel case, the fuel distribution layer having pores;
an anode gas diffusion layer formed on the fuel distribution layer to receive the fuel transported from the fuel case through the fuel distribution layer;
a membrane electrode assembly comprising an anode electrode layer formed on the anode gas diffusion layer, a cathode electrode layer and an electrolyte membrane interposed between the anode electrode layer and the cathode electrode layer; and
a cathode gas diffusion layer formed on the cathode electrode layer, the cathode gas diffusion layer being thinner than the anode gas diffusion layer.

11. The fuel cell of claim 10, wherein the fuel distribution layer is formed with an area corresponding to the anode electrode layer.

12. The fuel cell of claim 10, wherein the fuel distribution layer is made of polytetrafluoroethylene (PTFE) resin having a hydrophobic property.

13. The fuel cell of claim 10, wherein the fuel case further has a gas outlet formed on a region of the fuel case where the anode gas diffusion layer is mounted, and a hydrophobic film covering the gas outlet to selectively emit gas from the anode gas diffusion layer to an outside of the fuel case.

14. The fuel cell of claim 13, wherein the gas outlet is formed on an upward surface of the fuel case.

15. The fuel cell of claim 13, wherein the hydrophobic film is made of one selected from the group consisting of polytetrafluoroethylene (PTFE), polyethylene (PE), polypropylene (PP), and polyethylene terephthalate (PET).

16. A fuel cell comprising:
a fuel case storing fuel;
a fuel distribution layer having pores and made of hydrophobic material, the fuel distribution layer distributing the fuel to an anode gas diffusion layer;
the anode gas diffusion layer diffusing the fuel from the fuel distribution layer into an anode electrode layer, the anode gas diffusion layer diluting the fuel with water transported from a cathode electrode layer;
a membrane electrode assembly comprising the anode electrode layer, the cathode electrode layer and an electrolyte membrane interposed between the anode electrode layer and the cathode electrode layer; and
a cathode gas diffusion layer formed on the cathode electrode layer, the cathode gas diffusion layer diffusing air into the cathode electrode layer, a thickness of the cathode gas diffusion layer being thinner than the anode gas diffusion layer.

17. The fuel cell of claim 16, wherein a concentration of the fuel stored in the fuel case is equal to or more than 5 M.

18. The fuel cell of claim 16, wherein the fuel distribution layer is made of polytetrafluoroethylene (PTFE).

19. The fuel cell of claim 16, wherein the fuel case has a gas outlet and a hydrophobic film covering the gas outlet to selectively emit gas from the anode gas diffusion layer to an outside of the fuel case.

20. The fuel cell of claim 16, wherein the fuel distribution layer is made of material having thermal expansion coefficient of at least 12×10⁻⁵/° C.
